(19) United States
(12) Patent Application Publication
(10) Pub. No.: US 2023/0159124 A1
(43) Pub. Date: May 25, 2023

(54) COVER FOR PASSENGERS OF AN ELECTRIC CARGO BIKE

(71) Applicant: Rad Power Bikes Inc., Seattle, WA (US)

(72) Inventor: Trevor KNAPP, Seattle, WA (US)

(21) Appl. No.: 17/535,037

(22) Filed: Nov. 24, 2021

(51) Int. Cl. B62J 17/083; B62J 7/04; B62J 1/16

(52) U.S. Cl. CPC B62J 17/083; B62J 7/04; B62J 1/16

(57) ABSTRACT

A cover or enclosure that protects a rear portion of an electric bicycle, such as an electric cargo bicycle, is described. The cover, which can be a modular cover (e.g., an enclosure formed of a covering material and a frame) and/or a child/passenger cover (e.g., a cover suitable to contain one or two children), includes a covering that stretches around a frame that mounts to a rear rack or cargo area of a bicycle. When not in use, the frame is detachable, foldable, and/or stowable, such that the frame can be transported and easily assembled in advance of subsequent uses.

### BACKGROUND

Electric bicycles, or e-bikes, are a popular method of transportation for use by individual riders, families, commercial enterprises and fleets, and so on. Unlike traditional bikes, an e-bike provides assisted modes of travel to a rider, including a peddle assist mode that utilizes power from a motor to assist the rider in pedaling and/or a throttle mode where the motor, when engaged, powers the e-bike without any pedaling from the rider.

Often, electric bicycles (and other bicycles) are used in cold, damp, windy, or wintry conditions. These bicycles can be adapted to carry passengers or cargo, such as via rear-mounted racks or seats. Thus, during such conditions, cargo can get wet and/or destroyed, and passengers will often be uncomfortable (e.g., cold, wet, and so on). An electric bicycle, therefore, should be able to be utilized as intended in many or all conditions and environments.

### BRIEF DESCRIPTION OF THE DRAWINGS

Embodiments of the present technology will be described and explained through the use of the accompanying drawings.

FIG. 1 is a diagram illustrating a modular cover for a rear rack of an electric cargo bicycle.

FIGS. 2A-2C are diagrams illustrating the cover of the modular cover.

FIG. 3 is a diagram illustrating a frame via which the cover is mounted to a rear rack of an electric bicycle.

FIG. 4 is a diagram illustrating the securing of the cover to the frame.

FIGS. 5A-5C are diagrams illustrating components of the cover.

FIGS. 6A-6B are diagrams illustrating a sun cover for use with the frame.

In the drawings, some components are not drawn to scale, and some components can be combined for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

A cover or enclosure that protects a rear portion of an electric bicycle, such as an electric cargo bicycle, is described. The cover, which can be a modular cover (e.g., an enclosure formed of a covering material and a frame) and/or a child cover (e.g., a cover suitable to contain one or two children), includes a covering that stretches around a frame that mounts to a rear rack or cargo area of a bicycle. When not in use, the frame can be disassembled and stowed, such that the frame can be transported and easily assembled in advance of subsequent uses.

While described herein with respect to an electric bicycle, in some embodiments aspects of the cover described herein can be configured or utilized with other bicycles or cycles, electric scooters or other wheeled micro-mobility vehicles, mopeds, and so on. Thus, the cover, in some embodiments, can be configured to attached to any or all vehicles having a rear mounted cargo rack or seating area.

Various embodiments of the modular cover will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of the Modular Cover

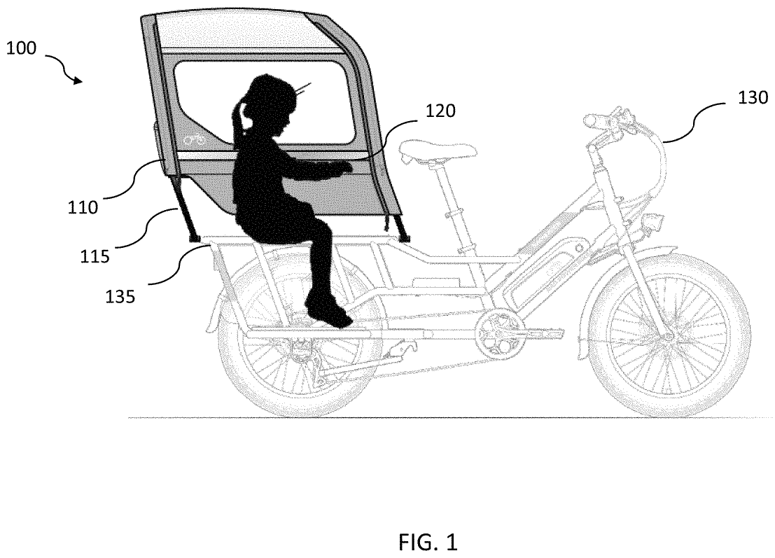

As described herein, a modular cover or enclosure that protects a rear portion of an electric bicycle, such as an electric cargo bicycle, is described. FIG. 1 is a diagram illustrating a modular cover 100 for a rear rack of an electric cargo bicycle. The modular cover 100, or child cover or protective enclosure, includes a flexible covering 110 and a frame.

The modular cover 100 is mounted to a rear rack 135 of an electric bicycle 130 via a mounting accessory 115, such as a “caboose” accessory or other accessory that attaches to the rear rack 135 and includes safety bars or other components to secure cargo and/or passengers to the rack 135. The cover 100 has a size or geometry to contain a child 120 within the cover 100 when the child 120 is being transported or carried by the bicycle 130 (e.g., via a child seat attached to the rear rack 135 of the bicycle 130). In some cases, the cover 100 can mount directly to the frame 135, without use of the mounting accessory 115.

As described herein, the electric bicycle 130 can be any type of bicycle or similar vehicle having a rack, such as the rear rack 135, that facilitates the carrying of cargo, passengers, and so on. For example, as depicted, the electric bicycle 130, or e-bike, is a long-tail cargo bike configured to be propelled either by human pedaling of the e-bike and/or via an electric motor that assists the human's pedal-power or propels the e-bike without pedaling (like a moped or scooter).

The electric bicycle 130 can include a head tube that incorporates a front fork and handlebars. A top tube connects the head tube to a seat tube, which is substantially parallel to the head tube. A down tube, parallel to the top tube, also connects the head tube to the seat tube at a bottom portion of the seat tube. A seat or saddle post is positioned partially in the seat tube and extends or protrudes outwardly from the seat tube. The seat post supports a seat or saddle, upon which a rider sits on the bicycle 130. Further, two chainstays (or one chainstay with two arms) extend from the bottom portion of the seat tube and each end at a dropout assembly (or dropout or forkend) of the bike frame. Two seatstays extend from a middle portion of the seat tube (an area where the top tube attaches to the seat tube) to the dropouts.

The rear rack 135 can be positioned in the rear of the electric bicycle 130. The rear rack 135 includes various support tubes or posts and is at least partially connected to and supported by the seatstays and the dropouts. Two cross members, or support stays, rack stays, or additional seatstays, attach to the rear rack 135 and extend to the top tube. The cross members extend around the seat tube, forming a space or opening defined by the cross members, the seat tube, and the top tube.

Thus, in some embodiments, these supports, such as the cross members or rack stays, provide fore/aft and/or lateral stabilization for the frame and the rear rack 135 of the bicycle 130, especially when the rear rack 135 carries a heavy or substantial load or cargo. For example, the bicycle 130 can be adapted to support one or two child passengers in child seats mounted or attached to the rear rack 135 of the bicycle 130, and the cover 135, being fixed to the rear rack 135 to protect objects positioned on the rear rack 135, can contain one or both children when deployed and/or mounted to the rear rack 135.

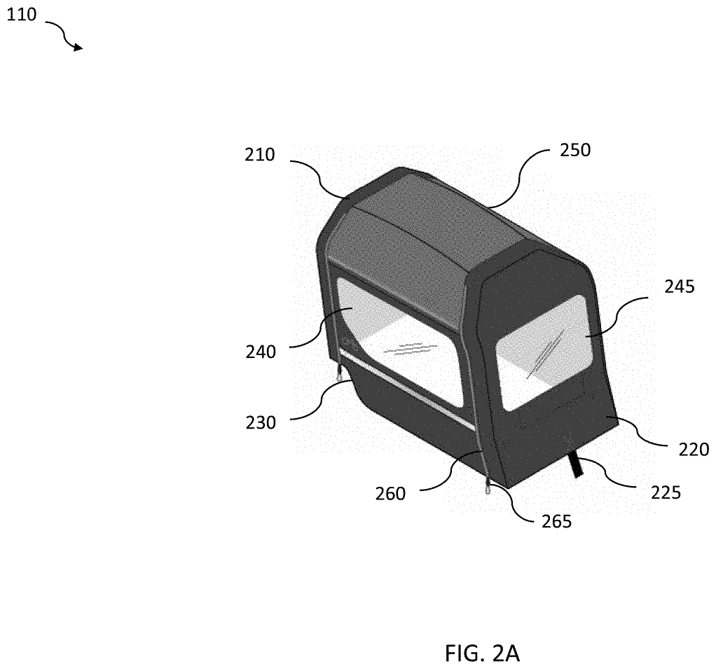

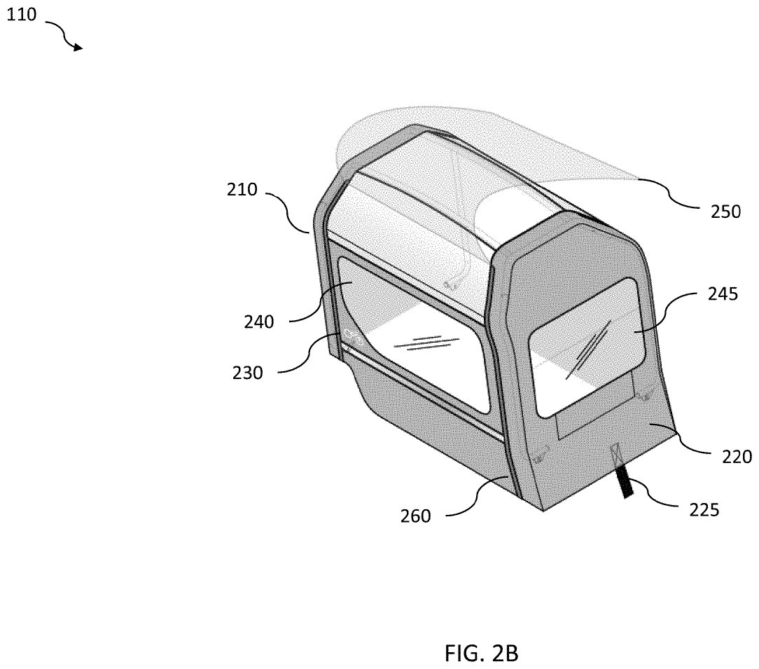

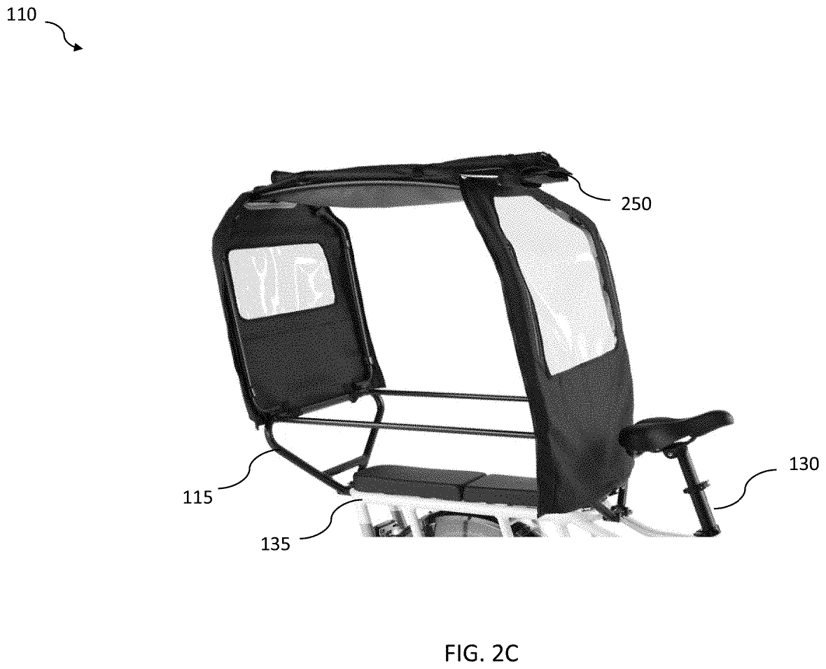

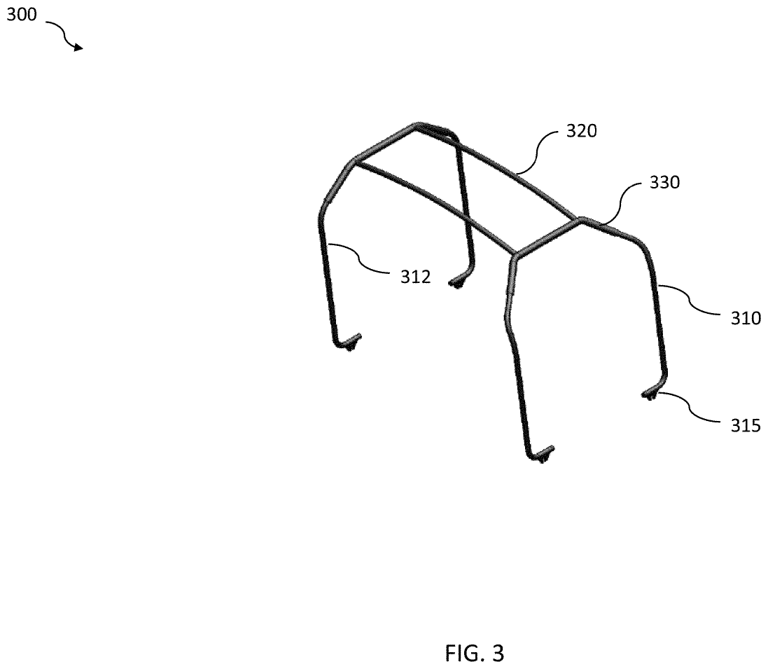

FIGS. 2A-2C are diagrams that further illustrate the modular cover. The cover includes the covering material or covering 110, and a frame (depicted in FIG. 3) that supports the covering and/or covering material. The covering can be disposed around the frame and removably fixed (e.g., stretched to fit) to various mounting portions or attachment points of the frame.

In some cases, the covering 110 includes a front portion 220, a rear portion 210, and two side portions 230. The front portion 220 includes a window 245, the rear portion 210 includes a window (not shown), and the side portions each include a window 240. The covering 110 also includes a top portion having an access window 250 that facilitates access to an internal area of the modular cover 100. Further, the front portion 220 can include an attachment strap or other pull mechanism that assists in pulling or stretching the covering 110 to the frame when being mounted.

For example, FIG. 2A depicts the access window 250 in a closed or secured position, and FIG. 2B depicts the access window 250 in an open or access position. In some cases, the access window 250 includes a left panel that is configured to open and fold over the top portion of the covering 110 to facilitate access to an internal area of the covering 110 via a left side, and a right panel that is configured to open and fold over the top portion of the cover to facilitate access to the internal area of the covering 110 via a right side of the covering 110.

The access window 250 can be secured in the closed position via a zipper 260 or other attachment mechanism that fixes the window 250 to the front portion 220 and/or rear portion 210 of the covering 110. Further, the covering 110 can include hooks 265 or loops that secure or attach the covering to the rack 135 or rack accessory 115. Thus, the access window 250 facilitates the entry and removal or cargo or passengers from the rear rack 135 (or seats positioned on the rear rack) without removing the covering 110 from the rack 135. Also, the covering 110 can be utilized in the open, closed, or partially open (e.g., one flap open) position, allowing a passenger to sit within the covering 110 and be protected as the weather dictates.

FIG. 2C depicts the access window 250 being rolled up and latched, where the cover is in an open or up position. Using such a configuration, the cover 110 can still be mounted to the mounting accessory 115 while also allowing air to circulate through to the inside. A strap, straps, or other securing mechanisms can keep the access window 250 in the up position while the bicycle is traveling.

In some cases, the covering 110 can include additional covering sections, such as a leg flap or flaps that extend from the side portions 230 of the covering 110 and/or are fixed to a frame of the cargo bicycle 130. The leg flaps (not shown) can provide additional coverage for a passenger of the bicycle 130 during bad weather conditions.

In some cases, the covering 110 can include various electrical devices powered by an electric battery of the electric bicycle 130. For example, the covering 110 can include various lighting devices, heaters, cooling devices, or other electric devices that are placed within the covering 110 and enhance a passenger's ride on the bicycle 130 during certain conditions (dark conditions, rainy conditions, cold conditions, hot conditions, and so on).

Further, the covering 110 can include various external devices, such as lighting devices, that are also powered by the battery of the bicycle 130. The covering 110 can include wiring that connects to electrical systems supported by the bicycle 130 in order to provide power to the devices.

As described herein, the modular cover 100 includes a frame that facilitates the mounting and removal of the covering 110 to the rear rack 135 of the bicycle 130. FIG. 3 is a diagram illustrating a frame 300 via which a cover is mounted to a rear rack of an electric bicycle.

The frame 300 includes a front mounting portion 310 that is configured to attach to a front portion of the rear rack 135 (via the accessory 115) of the cargo bicycle 130 and a rear mounting portion 312 that is configured to attach to a rear portion of the rear rack 135 (via the accessory 115) of the cargo bicycle 130. The frame 300 also includes a roof portion 320 that spans the front mounting portion 310 and the rear mounting portion 312.

In some cases, the rear mounting portion 312 and the front mounting portion 310 are removably attached to the roof portion 320 (via detents or attachment portions 330 that receive the portions 310, 312). In some cases, the rear mounting portion 312 and the front mounting portion 310 are foldably attached via to the roof portion 320 via hinges or other bendable components, such that the frame 300 can be positioned into multiple configurations. These configurations include a mounted configuration in which the frame 300 is attached to the rear rack of the cargo bicycle and/or a detached configuration in which the frame 300 is disassembled into separate components (e.g., the roof portion 320 and the mounting portions 310, 312) or a folded configuration in which the rear mounting portion 312 and the front mounting portion 310 are folded with respect to the roof portion 320 (e.g., folded under the roof portion 320).

The mounting portions can be attached to the mounting accessory 115 of the rear rack 135 in a variety of ways, include bolts or studs that fix the frame 300 to the rear rack 135 at various mounting points provided by the rear rack 135. Thus, in some cases, the frame, via the front mounting portion 310 and/or the rear mounting portion 312, can include attachment feet 315 that receive a bolt to attach to the mounting accessory 115 of the rear rack 135 of the cargo bike 130. The feet 315 can have a geometry that matches the mounting points of the mounting accessory 115 of the rear rack 135. Of course, in other configurations the frame can be mounted directed to the rear rack 135.

Thus, the frame 300 has a structure that facilitates mounting to the front and rear of the rear rack 135, allowing for easy entry or access to the internal area of the cover 110 when the cover is mounted to the rack 135. Further, the frame is detachable and/or foldable, allowing a rider to easily dis-assemble, fold, and/or stow the frame 300 and associated covering material when not in use, among other benefits.

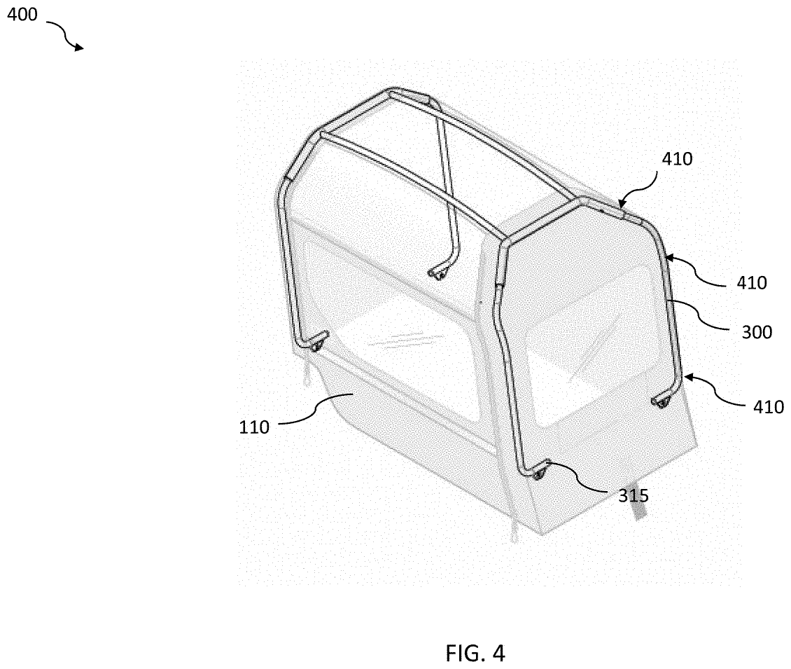

FIG. 4 is a diagram 400 showing an attachment of the frame 300 to the covering material. The covering 110 is stretched around the frame 300 and fixed to the front mounting portion 310 and the rear mounting portion 320 via internal attachment components 410. The attachment components 410 can include Velcro straps or other components that fix a portion of the cover (e.g., the covering material) to the frame 300.

In some cases, the covering can be stretched around the frame 300 and fixed to the front mounting portion 310 and the rear mounting portion 320 via external flexible attachment members, which facilitate the stretching and securing of the covering to the frame 300.

Thus, in some cases, the modular cover 100 can include a frame that mounts to a rear rack of a cargo bicycle, which includes a front mounting portion that is configured to attach to a front portion of the rear rack of the cargo bicycle, a rear mounting portion that is configured to attach to a rear portion of the rear rack of the cargo bicycle, and a roof portion that spans the front mounting portion and the rear mounting portion.

The modular cover 100 also includes a stretchable covering that attaches to the frame, such as to various internal or external attachment points or members. For example, the stretchable covering that attaches to the frame is disposed around the frame and removably fixed to the front mounting portion and the rear mounting portion of the frame. The stretchable covering includes, among other things, an access window that facilitates access to an internal area of the modular cover 100.

As described herein, the modular cover 100 has a structure that facilitates the mounting and removal of the modular cover 100 to the rear rack of a bicycle. For example, the rider of the bicycle can assemble a covered seating or storage area for the bicycle using the modular cover 100.

The process or method of assembling the modular cover 100 can include unfolding a one-piece frame that mounts to a rear rack of the electric cargo bike, mounting the unfolded frame to a front portion of the rear rack of the electric cargo bike and to a rear portion of the rear rack of the electric cargo bike, stretching a cover over the frame, and removably fixing the cover to the frame (pulling the cover to be tightly stretched over the frame).

In some cases, the one-piece frame can include various components, including a front mounting portion that is configured to attach to the front portion of the rear rack of the cargo bicycle, a rear mounting portion that is configured to attach to the rear portion of the rear rack of the cargo bicycle, and a roof portion that spans the front mounting portion and the rear mounting portion.

In other cases, the process or method of assembling the cover 100 can include inserting a rear mounting portion and a front mounting portion into a top portion of a frame that mounts to a mounting accessory of a rear rack of the electric cargo bike, mounting the frame to a front portion of the rear rack of the electric cargo bike via the mounting accessory and to a rear portion of the rear rack of the electric cargo bike via the mounting accessory, stretching a cover over the frame, and removably fixing the cover to the frame.

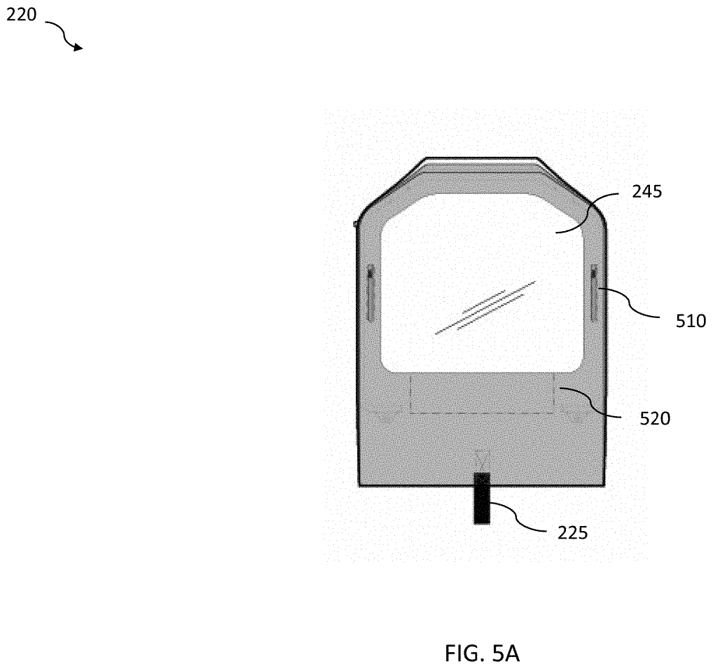

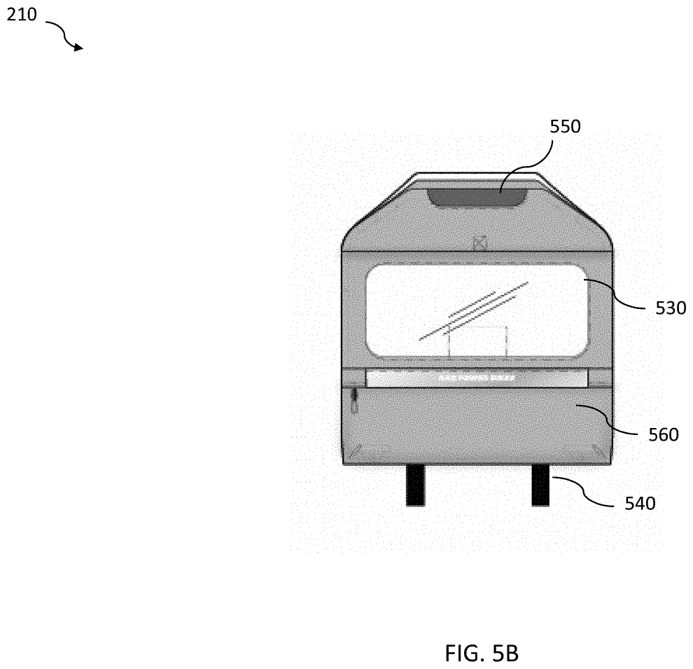

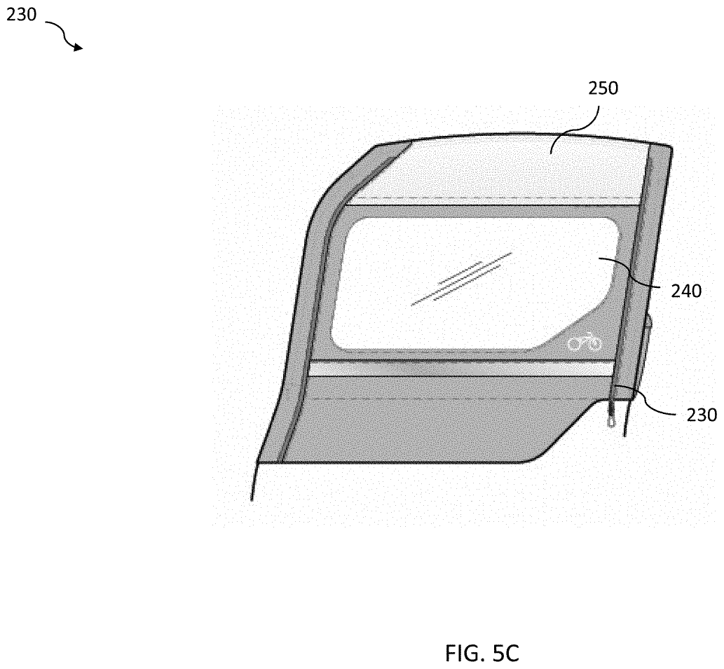

As described herein, the modular cover 100 includes various components that facilitate the entry of light or air into the enclosure, as well as various accessories to be utilized by passengers within the modular cover 100. FIGS. 5A-5C depict various components of the modular cover 100.

For example, as shown in FIG. 5A, the front portion 220 of the covering 110 includes the front window 245 and multiple air vents 510. The air vents 510, which can include zippers that facilitate the opening or closing of the vents 510, provide air flow into the modular cover from the front to the back of the enclosed space, such as when the bicycle 130 is in motion.

The front portion 220 can also include a storage pocket 520 fixed or attached to an inner surface. The storage pocket 520, which can be mesh or another flexible material, allows a passenger to secure various objects (e.g., toys, gloves, books, phones, and so on) while traveling on the bicycle within the enclosure.

FIG. 5B depicts the rear portion 210 of the covering. The rear portion 210 can include a rear window 530, additional pull straps 540, a light or reflector 550, and an internal storage pocket 560. The rear portion 210 can also include additional vents to assist in providing air flow into the enclosure, as well as additional reflective materials or lights, to assist in enhancing the visibility of the modular cover 100 (and thus the bike) during dark or other inclement conditions.

FIG. 5C depicts the side portions 230 of the covering. As described herein, the side portions 230 can include side windows 240 and the top window 250, which, via the zippers 260 or other similar mechanisms, can be opened to facilitate access or entry into the enclosure of the modular cover, and then closed to protect or secure cargo and/or passengers inside the cover. In some cases, the side portions 230 can include other components, such as reflectors or lighting, venting, and so on.

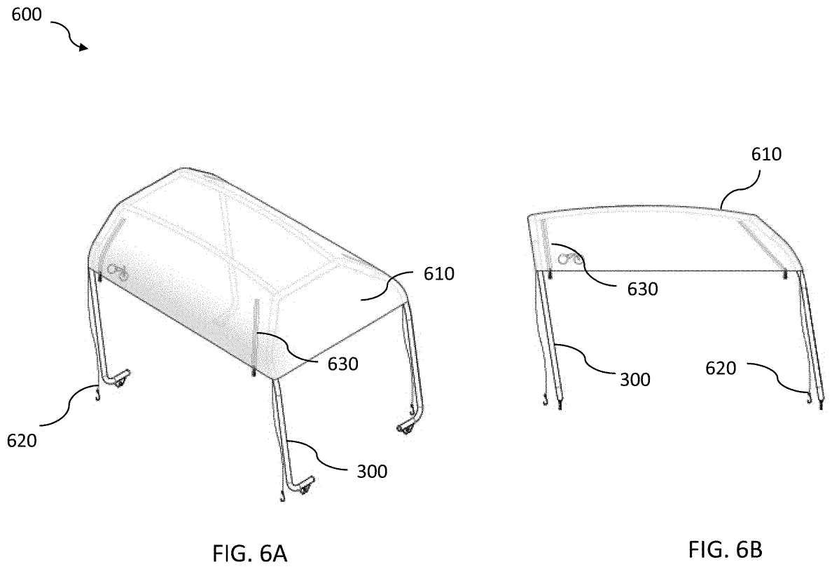

As described herein, the frame can support other types or shapes of coverings, such as coverings that are positioned above a passenger while the sides remain exposed. FIGS. 6A-6B are diagrams 600 illustrating a sun cover 610 for use with the frame. The sun cover 610, which can be formed of a reflective or light material (e.g., a white or light nylon fabric), can be stretched around the frame 300 and secured via securement straps 620 and/or at various attachment points 630 of the frame 300. Thus, the cover 610 can be a stretchable covering that attaches to the frame 300 and acts as a sun cover that is disposed over the roof portion of the frame, in order to provide a roof or top covering for a passenger or cargo.

The frame 300, therefore, can facilitate the attachment of different covers, depending on the environmental conditions during a ride and/or what is being transported by the bicycle 130.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the electric bike and bike frame may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. An apparatus, comprising
a frame that mounts to a rear rack of a cargo bicycle, the frame including:
a front mounting portion that is configured to attach to a front portion of the rear rack of the cargo bicycle;
a rear mounting portion that is configured to attach to a rear portion of the rear rack of the cargo bicycle; and
a roof portion that spans the front mounting portion and the rear mounting portion; and
a cover that is disposed around the frame and removably fixed to the front mounting portion and the rear mounting portion of the frame.

2. The apparatus of claim 1, wherein the rear mounting portion and the front mounting portion are foldably attached to the roof portion such that the frame can have at least two configurations, including:
a mounted configuration in which the frame is attached to the rear rack of the cargo bicycle; and
a folded configuration in which the rear mounting portion and the front mounting portion are folded with respect to the roof portion.

3. The apparatus of claim 1, wherein the cover is stretched around the frame and fixed to the front mounting portion and the rear mounting portion via internal attachment components.

4. The apparatus of claim 1, wherein the cover is stretched around the frame and fixed to the front mounting portion and the rear mounting portion via external flexible attachment members.

5. The apparatus of claim 1, wherein a top portion of the cover includes an access window that facilitates access to an internal area of the cover.

6. The apparatus of claim 1, wherein a top portion of the cover includes an access window, the access window including:
a left panel that is configured to open and fold over the top portion of the cover to facilitate access to an internal area of the cover via a left side of the apparatus; and
a right panel that is configured to open and fold over the top portion of the cover to facilitate access to an internal area of the cover via a right side of the apparatus.

7. The apparatus of claim 1, wherein the front mounting portion and the rear mounting portion each include attachment feet configured to receive a bolt when attached to the rear rack of the cargo bike.

8. The apparatus of claim 1, wherein the cover includes a front portion, a rear portion, and two side portions; and
wherein the front portion, the rear portion, and the two side portions each include a window.

9. The apparatus of claim 1, wherein the cover includes a front portion having a window and multiple air vents.

10. The apparatus of claim 1, further comprising:
at least one storage pocket fixed to an inner surface of the cover.

11. The apparatus of claim 1, further comprising:
a leg flap that extends from a side portion of the cover and is fixed to a frame of the cargo bicycle.

12. The apparatus of claim 1, wherein the cargo bicycle is an electric cargo bicycle, and wherein the cover includes at least one electrical device powered by an electric battery of the electric cargo bicycle.

13. The apparatus of claim 1, wherein an internal area formed by the cover disposed around the frame is configured to contain a child passenger sitting in a child seat attached to the rear rack of the cargo bicycle.

14. The apparatus of claim 1, wherein an internal area formed by the cover disposed around the frame is configured to contain passengers within two child seats attached to the rear rack of the cargo bicycle.

15. A child cover for a cargo bicycle, the child cover comprising:
a frame that mounts to a rear rack of the cargo bicycle, the frame including:
a front mounting portion that is configured to attach to a front portion of the rear rack of the cargo bicycle;
a rear mounting portion that is configured to attach to a rear portion of the rear rack of the cargo bicycle; and
a roof portion that spans the front mounting portion and the rear mounting portion; and
a stretchable covering that attaches to the frame.

16. The child cover of claim 15, wherein the stretchable covering that attaches to the frame is disposed around the frame and removably fixed to the front mounting portion and the rear mounting portion of the frame.

17. The child cover of claim 15, wherein the stretchable covering that attaches to the frame is a sun cover that is disposed over the roof portion of the frame.

18. The child cover of claim 15, wherein a top portion of the cover includes an access window that facilitates access to an internal area formed by the cover.

19. A method of assembling a seating area for an electric cargo bike, the method comprising:
inserting a rear mounting portion and a front mounting portion into a top portion of a frame that mounts to a mounting accessory of a rear rack of the electric cargo bike;
mounting the frame to a front portion of the rear rack of the electric cargo bike via the mounting accessory and to a rear portion of the rear rack of the electric cargo bike via the mounting accessory;
stretching a cover over the frame; and
removably fixing the cover to the frame.

20. The method of claim 19, wherein the roof portion connects and spans the front mounting portion and the rear mounting portion.
